(19) United States
(12) Patent Application Publication
(10) Pub. No.: US 2013/0080120 A1
(43) Pub. Date: Mar. 28, 2013

(54) Method for Optimal and Efficient Guard Tour Configuration Utilizing Building Information Model and Adjacency Information

(71) Applicants: Vinay Venkatesh, Bangalore (IN); Venkatesh Viswanathan, Bangalore (IN)

(72) Inventors: Vinay Venkatesh, Bangalore (IN); Venkatesh Viswanathan, Bangalore (IN)

(73) Assignee: Honeywell International Inc., Morristown, NJ (US)

(21) Appl. No.: 13/241,941

(22) Filed: Sep. 23, 2011

(51) Int. Cl. G06F 17/50

(52) U.S. Cl. 703/1

(57) ABSTRACT

A route planning system is provided. The system includes a mapping processor that extracts geometric information about a building from a building model of the building and generates an adjacency map of adjacent areas from the extracted information, a triangulation processor that translates each adjacent area of the adjacency map into a closed polygon representation and splits the closed polygon representation into a minimal group of triangles that covers the area where each triangle of the minimal group of triangles includes adjacency information derived from the adjacency map, a user interface that receives first and second locations within the building and a route processor that defines a route between the first and second locations by identifying a minimum set of triangles from the triangles that together form a continuous path between the first and second locations based at least upon the triangle adjacency information.

### FIELD

The field relates to security systems for buildings and more particularly to patrols by security guards in such buildings.

### BACKGROUND

Security systems are generally known. Such systems are typically based upon some type of physical barrier against entry by intruders into a secure area. In open areas, the physical barriers may be defined by a fence. In the case of buildings, the walls of the building and locks on doors and windows may define the physical barrier to entry.

While physical barriers are effective, such barriers cannot always be relied upon to ensure security. For example during normal working hours, employees may need to be present within the secured area in order to conduct the business of the owner of the secured area. Employees and vehicles may need to enter and exit the secured area. In order to accommodate the need for security in such cases, it may be necessary to provide one or more security guards in order to deter intruders.

In the case of security that covers large areas, it is often necessary and appropriate for security guards to patrol the secure area to discover and deter intruders. Watch stations may be provided at regular intervals throughout the area in such cases that must be activated by the security guards as a means of ensuring that the security guard has actually visited vulnerable areas. While such watch stations could be visited randomly, inevitably some watch stations would be visited more than others and some would not be visited at all, especially in the case of new installations. Accordingly, a need exists for better methods of arranging the paths that a security guard may travel between watch stations in order to enhance security and to maximize productivity.

### BRIEF DESCRIPTION OF THE DRAWING

FIG. 1 is a block diagram of a security system shown generally in accordance with an illustrated embodiment.

### DETAILED DESCRIPTION OF AN ILLUSTRATED EMBODIMENT

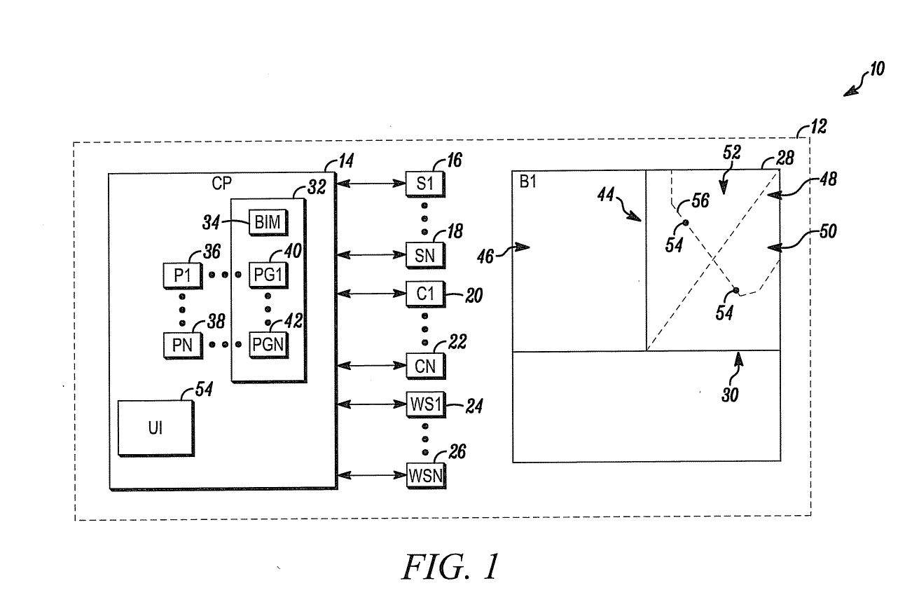

FIG. 1 is a block diagram of a secure area 12 protected by a security system 10, shown generally in accordance with an illustrated embodiment. Included within the security system 10 may be a control panel 14. One or more intrusion detectors 16, 18 may be provided to detect intruders within the secure area 12. The intrusion detectors 16, 18 may be perimeter switches, PIR or motion detectors.

The secured area 12 may also include one or more cameras 20, 22. The cameras 20, 22 may be distributed throughout the secured area 12.

Also included within the secured area 12 may be one or more watch stations (checkpoints) 24, 26. The watch stations 24, 26 may be periodically activated by security guards during patrols (tours) through the secure area 12 by inserting a special key or card into a card reader of the watch station.

The intrusion detectors 16, 18, cameras 20, 22, and watch stations 24, 26 may be connected to the control panel 14 via one or more wires. Alternatively, the intrusion detectors 16, 18, cameras 20, 22, and watch stations 24, 26 may be connected to the control panel 14 wirelessly via wireless transceivers located within each of the devices 16, 18, 20, 22, 24, 26 and the control panel 14.

The secure area 12 may include one or more buildings 28. The area within the buildings 28 may be divided into a number of smaller areas via one or more walls 30.

In general, the characteristics of each of the buildings 28 may be defined by a set of standardized parameters (geometric information) found within one or more data fields of a building model. In one embodiment, the building model is defined by a set of CAD drawings that are processed to extract the standardized parameters. In an even more preferred embodiment, the standardized parameters are defined by the format of the model (e.g., a building information model (BIM)). The parameters of the building model for each of the buildings 28 may be saved within a file 34 residing in a non-transitory computer readable medium (memory) 32.

Located within the control panel 14 may be one or more programmed processors 36, 38. The processors 36, 38 may be programmed by one or more software programs 40, 42 loaded from memory 32.

Upon start up of the system 10, a route planning system including one or more of the programmed processors 36, 38 may define one or more patrol routes for security guards within the secure area 12. In this regard, a first processor 36, 38 (e.g., a mapping processor) may extract geometric information about the buildings 28 from the building model file 34. Extracted information may include geometric information about the walls, doors, windows and other aspects of the buildings 28 from the file 34. The extracted information may include a coordinate system, the location, length and orientation of each of the walls within that coordinate system and the locations of doors and windows in those walls.

From the extracted information about the walls, the mapping processor 36, 38 may determine the dimensions and size of each area defined by the walls. The mapping processor 36, 38 may also generate an area adjacency map from the extracted information and from areas separated by walls. In this case, adjacency is identified by finding common edges (as represented by walls between areas in the building model data). This database 34 may use a graph data structure to represent this information. In addition, asset information may also be integrated into the building model file 34. In this case, the asset information may be used to provide a security level of each area containing the asset.

From the sizes of the areas and the adjacency map, the first or a second programmed processor (e.g., a triangulation processor) 36, 38 may create an triangulated adjacency map. In this case the processor may iterate through the set of areas (e.g., 46, 48) identified and collected by the first processor 36, 38 during creation of the adjacency map in the first step and translate each area into a closed polygon representation of the area. These polygons are then divided or split into a minimum set of triangles (e.g., 50, 52) that cover each of the areas. The triangulation may be accomplished using any of a number of different triangulation algorithms (e.g., ear clipping, monotone polygon decomposition, etc.). Each of the resulting triangles 50, 52 are stored in a list in memory 32. The triangulation processor 36, 38 also generates adjacency information for each of the triangles based upon dividing lines of the triangles and the adjacency map discussed above. The list of triangles 50, 52 and adjacency information of the triangles 50, 52 define the triangles adjacency map. The triangle adjacency map may also include a security rating for each triangle based upon the asset(s) within the respective triangles.

From the triangle adjacency map, the first or second (or a third) programmed processor (e.g., a route or routing processor) 36, 38 may generate one or more routes through the buildings 28. As part of this process, the routing processor 36, 38 may prompt a user for a starting or first location and ending or second location (e.g., a main entrance and exit) via a user interface 54. The routing processor 36, 38 may also prompt the user for optional limitations related to each route. Examples include the maximum time period to complete a route, the maximum checkpoints (watch stations 24, 26) per route, etc.

Once this information has been provided, the routing processor 36, 38 may begin to generate a route 56 through the building 28. As a first step, the routing processor 36, 38 (by reference to the building model and triangle adjacency map) may identify a first, starting triangle 50, 52 (nearest the first location) and a second, ending triangle 50, 52 (nearest the second location). Using the triangle adjacency information, the routing processor 36, 38 may then pick a minimal set of triangles 50, 52 that connect the starting and ending triangles. The routing processor 36, 38 may do this using some trial and error technique or some minimization algorithm based upon a direction vector from the starting to the ending points.

The centers 54 of the chosen minimal set of triangles define the route from the starting point to the ending point. In the case of a security guard, a watch station 24, 26 may be located in the center 54 of each triangle of the minimal set of triangles to define the patrol route. As such, the security guard would begin his patrol at the starting location, proceed to the watch station 24, 26 at the center of the starting triangle and register his presence. This process may be repeated at the watch station at the center of each successive triangle of the minimum set of triangles up to and through the ending triangle to the ending or second location.

This process of defining the route may be modified based upon the limitations entered by the user such as the maximum time per tour or maximum number of watch stations 24, 26. In this regard, the routing processor 36, 38 may calculate a distance of each route between the starting location and ending location. If the distance is too far to be covered with a normal walking speed, then the entered maximum time per tour may be used to divide the defined route into two routes to be covered by two different security guards or by the same security guard at a different time. Once the routing processor 36, 38 decides that the route must be divided, the process may be repeated. In this case, the selection of the minimum set of triangles may also include a lateral limitation that requires separation of the two routes by some average minimum distance. This allows the guards to tour the facility simultaneously thus reducing the time spent on guard tours.

The identification and defining of routes by the routing processor 36, 38 may be optimized using any of a number of different processes. For example, shortest path algorithms may be used to reduce the number of triangles in the final minimum set of triangles for a given tour. This may be done by drawing vectors between centers of adjacent triangles. The length of each vector may then be used to calculate the shortest path to be traversed by a guard in order to cover the maximum number of areas in the shortest possible time.

Alternatively, one or more topology discovery algorithms may be used to calculate the minimal set of routes required to completely cover the facility. The tour limitations defined by the user may also be considered when using these algorithms.

The route planning system may be integrated with the security system of panel 14 to automate operation of the guard tour sub-systems. In this regard, the defined routes including the distance of each route and locations of watch stations 24, 28 may be provided as inputs to a scheduling processor 36, 38. The scheduling processor 36, 38 may use such information to automatically create a tour timetable and guard schedules that are added to schedules that may already be present within the security system.

The route and building model information may also be incorporated into a building visualization processor including one or more of the processors 36, 38. In this case, a map of the secure area 12 may be created on a display of the user interface 54. The visualization processor 36, 28 may then superimpose one or more routes 56 on that map.

Other information may also be displayed on that map. For example, the visualization processor 36, 38 may also display the tour timetables on that map. A tour time processor 36, 38 within the visualization processor may cause each route 56 to be highlighted on the display as the tour is undertaken by a security guard. Alternatively, the area being visited during the tour may be highlighted. While the tour is underway, the visualization processor 36, 38 may show the watch stations 24, 26 and highlight the watch stations 24, 26 as the security guard checks in with each watch station 24, 26. The visualization processor 36, 38 may also activate one or more security cameras 20, 22 that view the area in which the guard is touring to observe the security guard during the tour.

The primary purpose of guard tours are to ensure that the security of the area 12 is constantly maintained. This can sometimes call for additional processes such as adding redundant guard tours (i.e., more than one guard may need to verify the security of a specific area). In response to this need, the user interface may include a scheduling feature (processing and screen) provided via a scheduling processor 36, 38 for initiating intermittent tours. In this case, the user may enter an identifier of a route 56 and a guard and a starting time of the tour. Alternatively, the scheduling processor 36, 38 may randomly generate starting times. The visualization processor 36, 38 may post the one time tour on the display and notify the guard via the display or short message service. The guard may respond appropriately.

The visualization and routing processors 36, 38 may also be used for other purposes. In the case of fire or other emergencies, first responders and other personnel may have to be routed to a specific location or locations in the shortest possible times. In this case, the user may be a security guard near a main entrance. In this case, the user may enter starting and ending locations through a local user interface 54. In response, the routing processor 36, 38 may instantly create one or more routes to a desired location. Similarly, the routing processor 36, 38 may be used to create escape routes for persons trapped by the same emergency.

The visualization and routing processors may also be used in the case of visitors. For example, the area 12 may have zones that vary in terms of security levels. For example, some zones may house personnel working on mission critical or defense projects while other zones may house personnel working on consumer grade products. In this case, visitors interested in the consumer grade products must be routed through paths that avoid contact with high security areas. In this case, a security guard or tour leader may use the user interface 54 to enter starting and ending locations along with a security level limitation. In this case, the routing processor 36, 38 may generate and print a map with a route that does not touch the areas (triangles) with a security level outside the security level limitation.

The route processing system can also be used for standards compliance. In this case, the route processing system can generate guard tour reports in the case of facilities where security compliance is mandatory and where an actual historical report of tour activity must be attached to an overall report when submitting requests for compliance evaluation. For example, facilities that need NERC compliance are required to identify and list the assets they contain and to perform a security assessment accordingly. For such requirements, a report containing details of the assets and the area in which each of them are located along with the guard tour reports that cover these areas can be automatically generated using the routing and visualization processors 36, 38.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. An apparatus comprising:
a mapping processor that extracts geometric information about a building including the locations of at least the walls and doors of the building from a building model of the building and generates an adjacency map of adjacent areas from the extracted information by locating common edges of the adjacent areas separated by the walls;
a triangulation processor that translates each adjacent area of the adjacency map into a closed polygon representation and splits or otherwise divides the closed polygon representation into a minimal group of triangles that covers the area where each triangle of the minimal group of triangles includes adjacency information derived from the adjacency map;
a user interface that receives first and second locations within the building from a user; and
a route processor that defines a route between the first and second locations by identifying a minimum set of triangles from the triangles of the adjacent areas that together form a continuous path between the first and second locations based at least upon the triangle adjacency information.

2. The apparatus as in claim 1 wherein the defined route further comprises a center point of each triangle of the identified minimum set of triangles.

3. The apparatus as in claim 2 wherein the building further comprises a secured area and the defined route identifies an assigned tour path of a security guard through the building.

4. The apparatus as in claim 3 wherein the center points of the minimum set of triangles identify checkpoints of the tour path.

5. The apparatus as in claim 4 further comprising the user interface receiving locations of a plurality of paired entrances and exits received from the user through the user interface where the routing processor defines a route between each paired entrance and exit of the plurality of paired entrances and exits.

6. The apparatus as in claim 1 wherein the building model further comprises a plurality of floors with at least one of the plurality of paired entrances and exits associated with each of the plurality of floors.

7. The apparatus as in claim 1 further comprising the first location defining an entry to the building by fire department personnel and the second location defining the location of a fire.

8. The apparatus as in claim 1 further comprising a security level assigned to at least some triangles of the minimum group of triangles.

9. The apparatus as in claim 8 further comprising the route processor programmed to defines the route between the first and second locations without crossing any of the at least some triangles with a predetermined level of security.

10. An apparatus comprising:
a first programmed processor that generates an adjacency map of adjacent areas within a building from a building model of the building;
a second programmed processor that translates the adjacency map into a respective minimal group of triangles that covers each of the areas of the building where each triangle of the minimal group of triangles includes information identifying adjacent triangles derived from the adjacency map;
a user interface that receives a starting location and an ending location for a patrol by a security guard within the building from a user; and
a third programmed processor that defines a route for the patrol between the starting location and ending location by identifying a minimum set of triangles from the triangles of the building that together form a continuous path between the starting location and ending location based at least upon the triangle adjacency information.

11. The apparatus as in claim 10 further comprising the first programmed processor programmed to extract geometric information about the building including the locations of at least the walls and doors of the building from the building model of the building and generates the adjacency map of adjacent areas from the extracted information by locating common edges of the adjacent areas separated by the walls.

12. The apparatus as in claim 10 further comprising the user interface receiving locations of a plurality of paired starting locations and ending locations received from the user through the user interface where the routing processor defines a patrol route for a security guard between each paired starting and ending locations of the plurality of paired starting and ending locations.

13. The apparatus as in claim 12 further comprising the user interface receiving a maximum time period allowed for a security guard to travel between the starting location and location of each defined route.

14. The apparatus as in claim 13 further comprising the user interface receiving a maximum number of checkpoints defined by the user that a security guard must visit between the starting location and ending location of each defined route.

15. The apparatus as in claim 14 further comprising a scheduling processor that establishes a schedule for each security guard between the corresponding starting location and ending location of each defined route.

17. The apparatus as in claim 15 further comprising location processor that generates a map of the building showing the defined routes and an indication of the location of each security guard on the map in real time.

18. The apparatus as in claim 17 further comprising a camera processor that activates a camera to view a scheduled location of the security guard.

19. An apparatus comprising:
a mapping processor that extracts geometric information about a building including the locations of at least the walls and doors of the building from a building model of the building and generates an adjacency map of adjacent areas from the extracted information by locating common edges of the adjacent areas separated by the walls;
a triangulation processor that translates each adjacent area of the adjacency map into a closed polygon representation and splits the closed polygon representation into a minimal group of triangles that covers the area where each triangle of the minimal group of triangles includes adjacency information derived from the adjacency map;
a user interface that receives a starting location and ending location for a patrol by a security guard within the building from a user;
a route processor that defines a route and schedule for the patrol between the starting location and ending location by identifying a minimum set of triangles from the triangles within the adjacent areas that together form a continuous path between the starting location and ending location based at least upon the triangle adjacency information; and
a video processor that activates one or more security cameras along the defined route to view the security guard as the security guard moves along the defined route.

20. The apparatus of claim 19 further comprising the user interface programmed to receive from the user a plurality of paired starting and ending locations for a patrol by respective security guard within the building.
